(19) United States
(12) Patent Application Publication
(10) Pub. No.: US 2026/0030497 A1
(43) Pub. Date: Jan. 29, 2026

(54) Threshold Modulation for Efficient Context Implementations

(71) Applicant: National Technology & Engineering Solutions of Sandia, LLC, Albuquerque, NM (US)

(72) Inventors: Corine Michelle Teeter, Albuquerque, NM (US); Craig Michael Vineyard, Cedar Crest, NM (US); James Bradley Aimone, Keller, TX (US); Peter Helfer, Montreal (CA); Dhireesha Kudithipudi, San Antonio, TX (US)

(73) Assignee: Board of Regents, The University of Texas System, Austin, TX (US)

(21) Appl. No.: 19/081,803

(22) Filed: Mar. 17, 2025

Related U.S. Application Data
(60) Provisional application No. 63/675,612, filed on Jul. 25, 2024.

(51) Int. Cl. G06N 3/08; G06N 3/044; G06N 3/048; G06N 3/049

(52) U.S. Cl. CPC G06N 3/08; G06N 3/044; G06N 3/048; G06N 3/049

(57) ABSTRACT

A context-modulated neural network is provided. The network comprises a number of neurons that receive input data, wherein a context modulates network activity by altering a number of network parameters such that network output depends on a combination of the context and the input data. A number of different sets of network parameters govern operation of the network, wherein the context determines which set of parameters is applied to the neurons.

### STATEMENT OF GOVERNMENT INTEREST

This invention was made with United States Government support under Contract No. DE-NA0003525 between National Technology & Engineering Solutions of Sandia, LLC and the United States Department of Energy. The United States Government has certain rights in this invention.

### BACKGROUND

### 1. Field

The present disclosure relates generally to memory storage and retrieval, and more specifically, to the use of context modulation in artificial neural networks for information processing.

### 2. Background

Animals and humans can use contextual information to interpret data in different situations. For example, the threat of a tiger will be interpreted very differently if a person observes a tiger in a zoo context versus while camping in the jungle context. Memory storage and retrieval is context sensitive: memories are more accurately retrieved in the context where they were acquired, and similar stimuli may elicit different responses in different contexts. The establishment of a context for memory retrieval may be achieved by a physical return to the place of learning or the reinstatement of relevant environmental cues but can also be effected by subtle reminders.

From a neuroscience perspective, it has been suggested that brain regions such as the CA3 subfield of the hippocampus may be modulated by context signals that bias the excitability of neurons, thereby adjusting the way a neural subsystem responds to inputs.

In general, ANNs comprise a set of one or more neurons processing information from inputs. These inputs are combined in some way via connections and weights to the neurons. Each neuron is defined by an activation function that processes the incoming data and provides an output signal to be used in some way. There are an infinite number of different possible ANNs comprising different activation functions connected in different ways. Activation functions can be continuous, such as linear, sigmoid, and rectified linear units (ReLUs), or discontinuous such as binary, linear leaky integrate and fire (LIF), or other more complicated spiking variations. Some common network architectures are convolutional neural networks (CNNs), recurrent neural networks (RNNs), feed forward neural networks (FFNN), long short-term memory (LSTMs), and transformers. Note that these terms are not necessarily exclusive, and a particular ANN often can fall into many different ANN categories.

### SUMMARY

An illustrative embodiment provides a context-modulated neural network. The network comprises a number of neurons that receive input data, wherein a context modulates network activity by altering a number of network parameters such that network output depends on a combination of the context and the input data. A number of different sets of network parameters govern operation of the network, wherein the context determines which set of parameters is applied to the neurons.

Another illustrative embodiment provides a context-modulated neural network. The network comprises a layer of input neurons and a reservoir comprising a recurrent neural network. Connections from the input neurons to neurons in the reservoir, and connections between the neurons in the reservoir, are sparse, randomly initialized, and fixed. Input data fed into the input neurons is projected onto the reservoir, wherein network activity of the reservoir is modulated according to a context. A readout layer classifies a reservoir state resulting from the input data and the context, wherein output connection weights in the readout layer are trained.

Another illustrative embodiment provides a method of training a context-modulated neural network. The method comprises inputting data into a number of neurons. A context is input to the neurons wherein the context modulates activity of the neurons and determines which of a number of context-dependent parameter arrays is applied to the neurons. The context-dependent parameter arrays define parameters of an activation function across the neurons based on the context.

The features and functions can be achieved independently in various examples of the present disclosure or may be combined in yet other examples in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 shows a diagram that depicts context modulation in a general neural network to provide an illustrative embodiment of the context modulation mechanism;

FIG. 2 is a diagram that depicts a Liquid State Machine with context modulation in accordance with an illustrative embodiment;

FIG. 3A depicts a graph comparing accuracy between separately trained LSMs and a single, context-modulated LSM;

FIG. 3B depicts a graph comparing total network size between separately trained LSMs and a single, context-modulated LSM;

FIG. 4 depicts an example of assigning classifications according to different contexts in accordance with an illustrative embodiment;

FIG. 5 depicts a graph contrasting the accuracy of speaker classification with and without context in accordance with an illustrative embodiment;

FIG. 6A depicts a table comparing the total number of arithmetic operations during a forward pass and the number of weight updates per training iteration in accordance with an illustrative embodiment;

FIG. 6B depicts a table compares energy consumption for the same networks, estimated for 32-bit and 16-bit floating-point operations in accordance with an illustrative embodiment;

FIG. 7 depicts a table comparing the accuracy of a context-modulated LSM to previously published LSM implementations in accordance with an illustrative embodiment; and

FIG. 8 depicts a flowchart illustrating a process for training a context-modulated neural network in accordance with an illustrative embodiment.

### DETAILED DESCRIPTION

The illustrative embodiments use inspiration from biological brains to develop a mechanism that enable artificial neural networks (ANNs) to process information in a context aware fashion. We provide a context modulation mechanism that enables ANNs to process information in a context sensitive manner.

The illustrative embodiments provide a context modulation mechanism for ANNs that is hardware and software agnostic; it can be implemented on common computers or deployed on specialized hardware.

Context modulation enables a network to interpret data differently in different contexts, such as in the previously mentioned tiger example above. In addition, context modulation enables a single network to perform multiple tasks and decreases the number of neurons required compared to the case in which smaller individual networks perform the same tasks separately. In essence, context modulation allows a network to use its computational components for more than one purpose.

In its simplest form the illustrative embodiments provide a mechanism to alter, or modulate, the value of a parameter or parameters in an ANN based on a context signal. A context is any set of circumstances that form the setting for an event, statement, or idea, and in terms of which it can be fully understood and assessed. Context modulation is defined as any method that alters a parameter or parameters of a network in a systematic way to enable the output of the network to depend on the combination of the context and the input data. Context can be related to, or independent from, the input data. Context can be sampled or sent as a signal.

Context can relate to factors both external and internal to the neural network. Context can relate to an external environment in which, or about which, the neural network has to learn, as well as to external factors related to input data or the conditions under which it is collected. For example, the context can be read by external sensors for factors such as light, sound, voice, motion, humidity, face recognition, fingerprint identification or other biometric reading, etc. For sound data, context might include intensity/loudness of the sound. Similarly, for visual or light data, context might include intensity/brightness. A specific user can affect the context. For example, the input might include voice data (what is being said), and the context includes who is speaking and how they are speaking. Data from multiple users can also be combined for training data to provide the neural network a greater cross-section of contexts and their relation to input data.

Context might also relate to an internal state of the system related to the subject on which the analysis is performed. Context can also encompass the type of problem the network has to perform (e.g., voice recognition versus video recognition or motion detection, or a combination of them).

Note that although we illustrate our context modulation mechanism using discrete contexts, a context can be continuous and alter parameters in a continuous fashion. This mechanism is not limited to any particular neural network architecture, parameters, activation functions, learning algorithm, or training paradigm. In our examples we alter the parameters of the activation functions, however a context could be used to systematically alter other parameters such as connectivity, weights or any other parameter associated with a neural network. Furthermore, as mentioned above, it is hardware and software agnostic and can be implemented on standard computing platforms or specialized hardware. In addition, although we illustrate our mechanism in a classification task, this mechanism is not limited to classification problems.

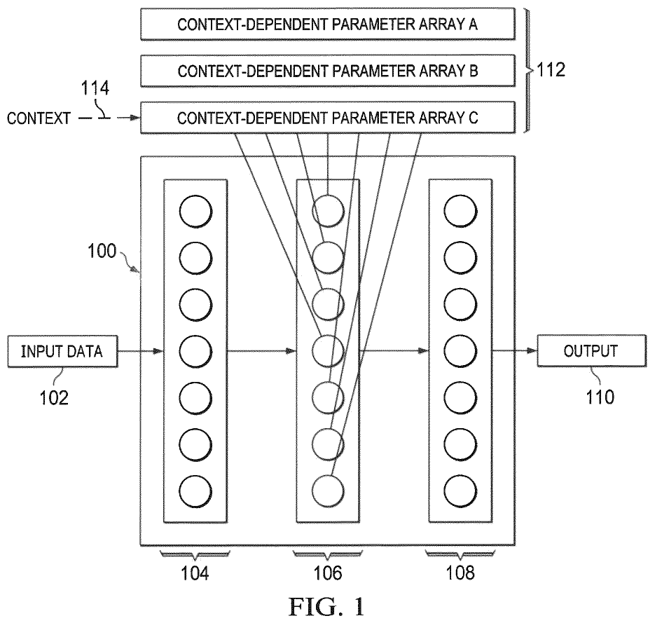

FIG. 1 shows a diagram that depicts context modulation in a general neural network to provide an illustrative embodiment of the context modulation mechanism. Neural network 100 comprises a layer of input neurons 104, a layer of hidden neurons 106, and a layer of output neurons 108. For simplicity of illustration, the present example only has one layer of hidden neurons connected in a feed forward architecture. However, it should be understood that the method of the illustrative embodiments can be applied to architectures comprising any number of hidden layers, as is utilized in deep neural networks (DNNs).

In general, the parameters of an ANN can be represented using different data structures including individual values, arrays, vectors, matrices, or tensors. Our context modulation mechanism may be implemented using any of these data structures. In the present example, we illustrate the context parameter modulation mechanism using arrays (comprising a string of index-based numerical values). Each single value in an array corresponds to a single parameter in an activation function of a neuron. A number of context-dependent parameter arrays 112 define the parameters of the activation function across the hidden neurons 106 based on specific context. Each context-dependent parameter array specifies the parameter values across the neural activation functions in a different context. The context-dependent parameter arrays 112 can be stochastically determined or deliberately assigned.

Input data 102 is fed into the layer of input neurons 104, which forwards the data to the layer of hidden neurons 106. As stated above, there may be multiple layers of hidden neurons, but only one is shown for ease of explanation.

A context 114 determines which of the context-dependent parameter arrays 112 is applied to the layer(s) of hidden neurons 106. The layer of output neurons 108 then generates output 110 based on the calculations of hidden neurons 106.

The principle of using context-dependent parameters is agnostic to architecture, parameter, activation function, learning algorithm, and training method. Below we illustrate our methodology within the framework of a reservoir computing architecture, which utilizes a recurrent neural network structure. However, it should be understood that the method of the illustrative embodiments is not limited to this scenario. Furthermore, we illustrate our context modulation algorithm on two example datasets: the Free Spoken Digit Dataset and the MotionSense dataset (described below). However, our context modulation algorithm is not limited to these data.

In analogy with the purported neural processes, the mechanism of the illustrative embodiments modulates the firing thresholds of spiking neurons in a recurrent neural network, thereby altering its dynamics in a context-dependent fashion.

The concept of reservoir computing was independently introduced by the publication of two algorithms, the Echo State Network (ESN) and the Liquid State Machine (LSM). Reservoir computing is a computational framework for training recurrent neural networks (RNNs) in a way that reduces the complexity of training while still capturing the temporal dynamics of input data. It is especially suited for time-series data and tasks that involve processing temporal patterns, such as speech recognition, time-series prediction, and dynamic system control. Reservoir computing exploits the behavior of a fixed network (the reservoir) and trains only a simple output layer, bypassing the need to train the entire recurrent network. The reservoir is a recurrent network of neurons, typically with random and fixed connections. It transforms the input signals into a higher-dimensional space. The reservoir captures the temporal dynamics of the input sequence, meaning the internal state of the reservoir changes over time as it processes the incoming data.

The ESN and LSM architectures differ in that the ESN uses conventional (continuous or rate based) neurons in the reservoir, whereas the LSM uses spiking neurons, but are otherwise very similar. For case of illustration, the description below focuses on the example of an LSM, but the principles of the illustrative embodiments are applicable to other forms of reservoir computing such as ESNs as well as other ANN architectures.

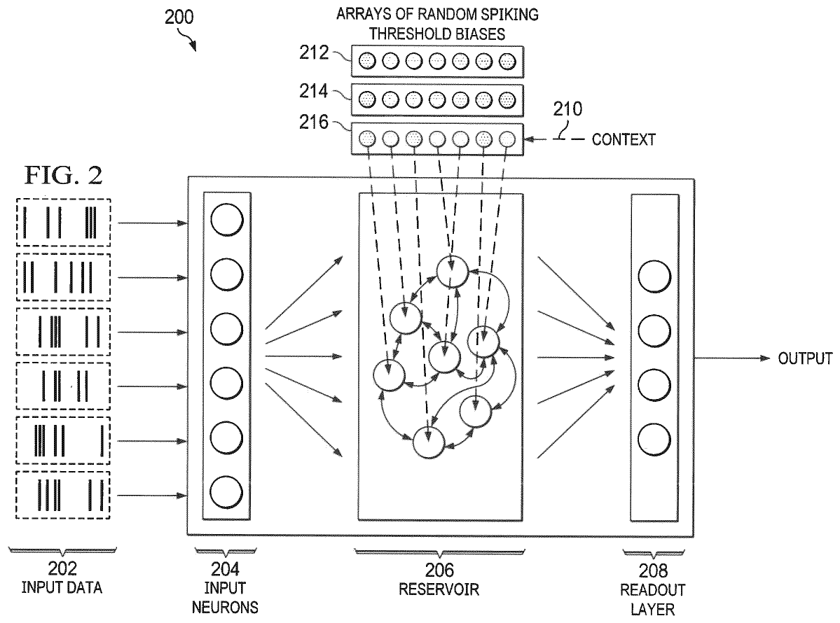

FIG. 2 is a diagram that depicts a Liquid State Machine with context modulation in accordance with an illustrative embodiment. The core idea of an LSM is to cast input data into a much higher dimensional representation with the intention of improving class separability of the data. Then, a readout layer is trained to classify on the higher dimensional representation. This process is implemented by projecting time-series data onto a recurrently connected set of spiking neurons (the reservoir or liquid), then read the state of the reservoir and classify it using a simple feedforward readout layer, which is fully connected to the reservoir.

LSM 200 comprises a layer of input neurons 204, a recurrent spiking reservoir 206, and a readout layer 208. The connections from the input neurons 204 to the neurons in the reservoir 206, as well as the connections between reservoir neurons, are sparse and randomly initialized but fixed and do not change during training or inference. Learning occurs only in the readout connections of readout layer 208. Only output connection weights in the readout layer 208 are trained. In this manner, the readout layer learns to discern patterns of activity in the liquid to differentiate between how different inputs drive different activity dynamics. Input data 202 are fed to the input neurons 204, which project the received values onto the reservoir 206, resulting in spiking activity.

LSM 200 further comprises parameter arrays 212, 214, 216 of spiking threshold biases. Each array represents a different context and includes a separate respective bias for each spiking neuron in reservoir 206. The bias values in arrays 212, 214, 216 can be stochastically determined or deliberately assigned.

In the case of an ESN in place of an LSM, the discontinuous spiking activation function can be replaced with a continuous activation function, and the parameter arrays will define the parameters of the chosen activation function. For the LSMs shown here, the activation function for each neuron is of the form of the combination of Equations 1, 7 and 8. The thing that differentiates the activation function of each individual neuron is the parameters of those equations, i.e., in Equation 1, τₘₑₘ could be different for each neuron. The threshold (vthreshᵢ in Equation 8) for each neuron is changed depending on the context. It is changed by assigning a different bias_{ci} in Equation 8 depending on the context c.

For example, given three neurons where each neuron is identified by identified by and index i, i.e. neuron₁, neuron₂, and neuron₃, the voltage of each neuron is defined by Equation 1. When the voltage of each individual neuron becomes larger than the voltage threshold of each individual neuron (vthreshᵢ in Equations 7 and 8), the individual neuron will “spike.” The threshold of each neuron is defined as the base threshold (vthresh_{base})+the bias threshold (bias_{ci}). In artificial neural networks it is convention to represent the parameters across the different neural activation function as arrays. Here the context array would be [bias_{c1}, bias₂, bias_{c3}], which indicates what the values are for the biases of each neuron.

Assuming two contexts, e.g., a red context and a blue context, there would be two context threshold bias arrays: context_{red}=[bias_{red1}, bias_{red2}, bias_{red3}] and context_{blue}=[bias_{blue1}, bias_{blue2}, bias_{blue3}]. Therefore, e.g., bias_{red1} gives the value of the threshold bias (bias_{ci}) for neuron 1 in context red, and bias_{blue2} will give the value of the threshold bias for neuron 2 in context blue.

The FSDD (Free Spoken Digit Dataset) comprises 3000 voice recordings of six speakers pronouncing the digits zero through nine in English. These recordings can be pre-processed into standard 13 mel-frequency cepstral coefficients (MFCCs).

A context 210 determines which spiking threshold bias array is applied to the reservoir 206. Readout layer 208 then classifies the context-modulated reservoir state resulting from the input data 202.

The reservoir comprises leaky-integrate-and-fire (LIF) neurons whose dynamics are defined by the following equation:

$${V}_{i} ( t + 1 ) = {V}_{i} ( t ) + \frac{t}{{τ}_{m e m}} {V}_{i} ( t ) + {I}_{i} ( t ) R \qquad Eq . 1$$

where Vᵢ(t) is the membrane potential of neuron i at time t, lᵢ(t) is the input current to neuron i, R is the membrane resistance, τₘₑₘ and is the membrane time constant. t is the length of a time step.

The input current to neuron i is the sum of the incoming currents from other neurons:

$${I}_{i} ( t ) = {\sum }_{j 1}^{{N}_{i n p}} {w}_{i j} {A}_{j} ( t ) + {\sum }_{k 1}^{{N}_{r e s}} {w}_{ik} {S}_{k} ( t ) \qquad Eq . 2$$

where wᵢⱼ is the connection weight from input neuron j to reservoir neuron i, Aⱼ is the activation level of input neuron j, w is the connection weight from reservoir neuron k to reservoir neuron i, and Sₖ is 1 if reservoir neuron k spikes at the current time step, otherwise 0. Nᵢₙₚ and Nᵣₑₛ are the numbers of input and reservoir neurons, respectively.

When a neuron's membrane potential crosses a threshold Vₜₕᵣₑₛₕ, a spike is emitted (Sᵢ 1), and the membrane potential is reset to zero (Vᵢ 0). After a neuron spikes, there is a short time interval during which it cannot spike, known as the refractory period.

Each reservoir neuron i is equipped with an “x-trace,” Xᵢ, a leaky integrator that serves as a decaying memory of the neuron's spiking activity:

$${X}_{i} ( t + 1 ) {X}_{i} ( t ) ( 1 \frac{1}{{τ}_{x t r a c e}} ) + {S}_{i} ( t ) \qquad Eq . 3$$

where τ_{xtrace} defines the decay rate and Sᵢ(t) is 1 if neuron i spikes at time step t, 0 otherwise.

The readout layer comprises sigmoid neurons:

$${f}_{i} ( t ) \frac{1}{1 {e}^{{Y}_{i} ( t )}} \qquad Eq . 4$$

where fᵢ(t) is readout neuron i's activation level at time t, and Yᵢ(t) is its instantaneous input, a weighted sum of the x-trace values:

$${Y}_{i} ( t ) {\sum }_{j 1}^{{N}_{r e s}} {w}_{i j} {X}_{j} ( t ) \qquad Eq . 5$$

where wᵢⱼ is the connection weight from x-trace j to output neuron i. The readout layer is trained to map input samples to one-hot encodings of the corresponding labels, i.e., the index of the readout neuron with the highest activation level is the network's prediction for the label:

$$pred = arg {max}_{i} {f}_{i} ( t ) \qquad Eq . 6$$

The illustrative embodiments bias the reservoir neurons' firing thresholds so that, depending on the current context, different subpopulations of the reservoir are more or less prone to fire. This can be thought of as remodeling the reservoir's “energy landscape” so that spiking activity is directed to different parts of the reservoir depending on which context is active, with the aim of improving pattern separation and facilitating classification.

The LSM's globally defined firing threshold Vₜₕᵣₑₛₕ is replaced with a neuron-specific firing threshold vthreshᵢ, and the condition for spiking becomes:

$${S}_{i} ( t ) \{ \begin{matrix}1 , & if {V}_{i} ( t ) {vthresh}_{i} \\ 0 , & otherwise\end{matrix} \qquad Eq . 7$$

where Sᵢ(t) indicates whether neuron i is firing, and Vᵢ(t) is neuron i's membrane potential at time t.

Whenever a context is activated, the neuron-specific firing thresholds vthreshᵢ are set to values specific to that context. Those values are determined by letting N_{ctx} be the number of contexts for a given classification task. The different contexts are identified with integer IDs c=0, 1, 2, . . . , N_{ctx}−1.

For each context ID c, there is a unique array of firing threshold biases with length Nᵣₑₛ, the number of neurons in the reservoir. Therefore, there is an array of biases, bias_{ci}, with N_{ctx} rows, one per context ID. Each row is an array of Nᵣₑₛ bias values, one for each reservoir neuron. When a particular context, say context c, is activated, the firing threshold for each reservoir neuron i is set to a base threshold vthreshold_{base}, plus the value of the corresponding element of the bias array for context c:

$$v t h r e s {h}_{i} = vthres {h}_{b a s e} + {bias}_{c i} \qquad Eq . 8$$

To achieve a smooth variation of biases, the bias arrays are created by randomly permuting a template array templ that is initialized with a Gaussian distribution of bias values:

$${templ}_{i} = {max}_{b i a s} * {e}^{\frac{{k}_{b i a s}}{r e s} {( i - \frac{r e s}{2} )}^{2}} \qquad Eq . 9$$

where max_{bias} and k_{bias} are configurable parameters.

During training, the context ID for each sample is supplied from the environment. During testing, context IDs may similarly be supplied to the network (“known context mode”), simulating a scenario where each test sample is presented in the same context where it was learned.

The MotionSense human activity recognition dataset comprises motion data recordings from a smartphone's acceleration, attitude, and gyroscope sensors when worn by 24 participants engages in any of six activities (sitting, standing, walking, jogging, walking upstairs, and walking downstairs). There are 216 recordings designated for training and 144 for testing. The lengths of the recordings vary considerably. To obtain a uniform dataset, the recordings can be split into five-second samples, resulting in 4214 training samples and 1247 testing samples, labeled with activity type.

The LSM's performance on a dataset is evaluated by executing a series of train/test cycles. For the FSDD dataset, each cycle comprises the following steps:
(1) The dataset, comprising 3000 labeled samples, is randomly split into a training set (2700 samples) and a test set (300 samples).
(2) The LSM is then trained on the training set for 50 epochs. The order of the training samples is randomized for each epoch. Each sample is processed through the LSM, whereupon the readout weights are updated using gradient descent (online training).
(3) The accuracy of the trained LSM is then tested by processing the test samples and calculating the proportion of correctly labeled samples.

Each accuracy value reported in the results section is calculated by executing ten train/test cycles and taking the mean and standard deviation of the test accuracies.

The procedure is the same for the MotionSense dataset, except that a) the training and test datasets are predefined, so there is no random splitting into train/test samples, and b) the number of samples is 4214 for training and 1247 for testing.

The configuration of an LSM is controlled by a number of hyperparameters. Some hyperparameters directly control attributes of network elements, for example τₘₑₘ, the membrane time constant for the LIF neurons. Others hyperparameters are used to parameterize the random initialization of the LSM. For example, the probability of a connection between any two reservoir neurons is C·e(D/λ)², where D is the distance between the two neurons and C and λ are hyperparameters. We use a genetic algorithm (GA) to find a good set of hyperparameter values for a classification task, using a train/test cycle as defined above to evaluate the fitness of a set of parameter values.

However, the random initialization still leaves room for considerable variation in accuracy between LSMs configured with the same set of hyperparameter values. The problem of finding a “good reservoir” has been discussed in the literature. Here we use a simple heuristic: We repeatedly (e.g., 50 or 100 times) instantiate and initialize LSMs using the optimized set of hyperparameters, execute a single train/test cycle with each such randomly initialized LSM instance on the task, and select the instance that achieves the highest accuracy. This means that, when evaluating an LSM's performance for a given task, we use the best set of input and reservoir connections that we have found for that task, together with a fixed set of threshold bias arrays (when using context modulation). The weights in the readout layer are still randomly initialized and trained in each train/test cycle.

When we trained a single LSM to identify spoken digits in the FSDD dataset without a context, we achieved an accuracy of 0.958±0.012. We then applied context modulation to the LSM by using the speaker as a context. Using known speaker IDs resulted in an accuracy of 0.973±0.010, a 1.5% improvement over baseline.

We see similar results when applying context modulation to the MotionSense dataset. Here participant ID (0-23) is used as the context, and activity type (one of six) is used for the classification target. With this dataset, accuracy without context modulation was 0.946±0.003. With known participant ID, the accuracy was 0.954±0.002, a 0.8% improvement over the baseline.

Although these improvements are small, they do show that the context modulation technique can aid in classification on two separate datasets.

Above we showed that a context can improve the ability of a network to perform classification. The best results were achieved when the context was available both during training and testing. This raises the question: If context is known, why perform classification in different contexts on one network? Why not use separate networks for each context? Here we use the FSDD dataset to show that using one network with a context reduces the number of neurons needed to reach equivalent accuracy between individual networks and a context network.

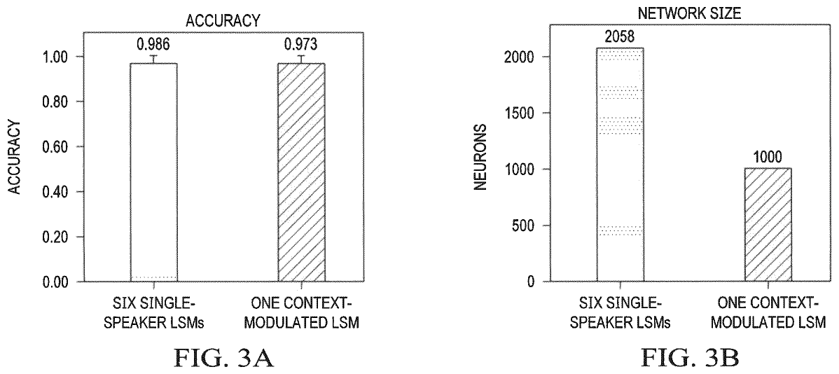

We trained six separate LSMs to each classify sample from one of the six speakers. The mean accuracy for individual speakers varied between 0.974 and 0.992 depending on speaker, with an overall mean of 0.986±0.017 (see FIG. 3A). The accuracy of a single LSM with context modulation is somewhat lower than the mean accuracy for single-speaker networks. When we trained a single LSM on the complete FSDD dataset without context, we achieved 0.958±0.012 accuracy, 2.8% below the mean single-speaker performance. Context modulation improved the accuracy to 0.973±0.010 using known speaker IDs, 1.3% below mean single-speaker accuracy.

Although using a single LSM with context modulation does not improve accuracy over using multiple individual networks, it does substantially reduce the number of neurons needed to achieve high accuracy. The accuracy values were obtained using a cube-shaped reservoir with 10³=1000 neurons for each network. Thus, although individual networks achieve higher average accuracy, more neurons are used to achieve this result (6*1000 neurons using multiple individual networks versus 1000 neurons for one network with context modulation). To quantify how large individual networks need to be to achieve high accuracy, we decrease the size of the networks. The size of the individual-speaker digit classification networks can be reduced to 343 neurons and still achieve the accuracy obtained by the single 1000-neuron LSM with context modulation. Although 343 is less than 1000, six networks are required. Using context modulation to handle all six speakers with a single 1000-neuron LSM thus resulted in an overall reduction of reservoir size by 51.4%, 1000 vs. 2058 (6*343) (see FIG. 3B) while still maintaining nearly the same level of accuracy as the separate networks. Thus, the use of individual networks comes at the cost of a larger combined network size. Interestingly, these results also show that the context-modulated network does not simply use separate subsets of neurons while in different contexts; instead, individual neurons contribute to more than one context.

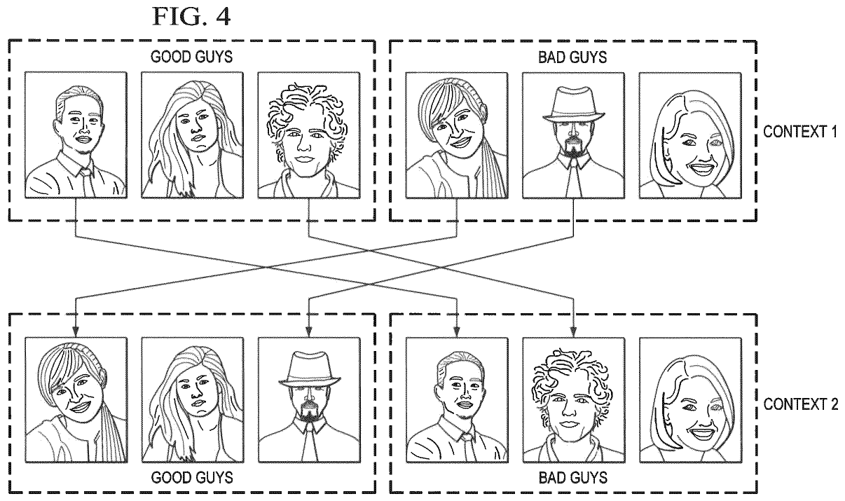

FIG. 4 depicts an example of assigning classifications according to different contexts in accordance with an illustrative embodiment. Our biological brains are capable of applying different classifications to the same objects depending on context. For example, an actor may play “bad guy” in a first movie and a “good guy” in a second movie. Humans can easily classify whether the same actor is good or bad based on context (whether they are watching the first or second movie). To explore if context-modulated LSMs are capable of this type of behavior, we devised an experiment where identical data had to be classified differently depending on context.

We assigned each of the six speakers in the FSDD dataset to one of two groups, A or B, and labeled each speech sample with its speaker's group ID. As a “baseline” group assignment, we assigned the first speaker to group A, the second speaker to group B, etc.: ABABAB. The LSM was trained to classify the speech samples according to group labels (withholding speaker IDs and digit classes), achieving an accuracy of 0.931±0.014.

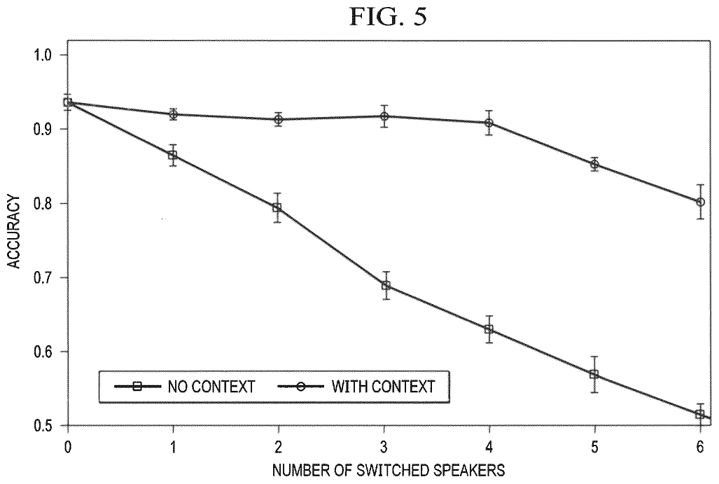

We then created modified speaker-to-group mappings that differed from the baseline in one, two, three, four, five or all six positions: BBABAB, BAABAB, BABBAB, BABAAB, BABABB, BABABA. The LSM was trained with a mix of samples labeled either according to the baseline mapping or according to one of the modified mappings. As in the digit recognition task, we randomly split the dataset into 90% training samples and 10% test samples for each train/test cycle. During both training and testing, a context was supplied, indicating which mapping was in effect (“known context”). As shown in FIG. 5, context modulation enabled the simultaneous learning of both mappings in the same LSM with little or no accuracy loss even when as many as four of the six speakers had different group assignments in the two mappings. The same reservoir size (1000 neurons) was used as in the previous experiments.

Because an LSM's input-to-reservoir connections and intra-reservoir connections are sparse and fixed, its model size and energy consumption compare favorably to other recurrent networks. To illustrate this point, we estimate the number of compute operations and the energy requirements for our LSM implementation compared with an LSTM network with comparable performance on the FSDD task.

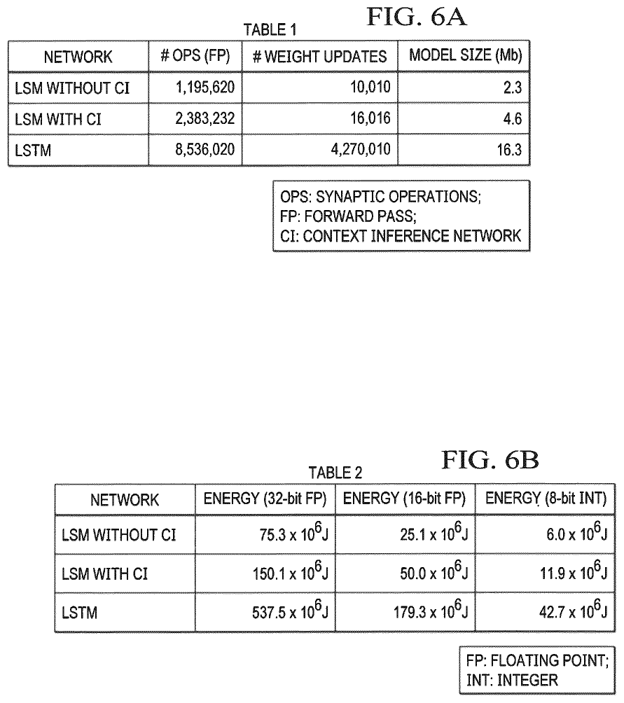

Table 1 in FIG. 6A compares the total number of arithmetic operations during a forward pass and the number of weight updates per training iteration, as well as memory requirements.

Table 2 in FIG. 6B compares energy consumption for the same networks, estimated for 32-bit and 16-bit floating-point operations. We also include 8-bit integer operations, which are supported in hardware by several recent machine learning accelerators.

As seen in the tables, the resource requirements for the LSM are considerably lower than for the LSTM: 85% smaller memory footprint and 86% lower energy cost. Even when including the auxiliary context inference network, the memory size is 71% smaller and the energy cost 71% lower than for the LSTM.

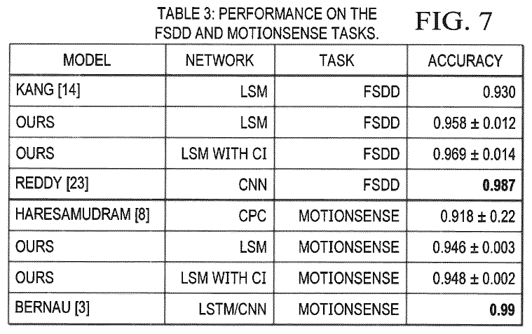

Table 3 in FIG. 7 compares our model's accuracy on the FSDD and MotionSense tasks with the best-performing previously published LSM implementation and state-of-the-art non-spiking networks.

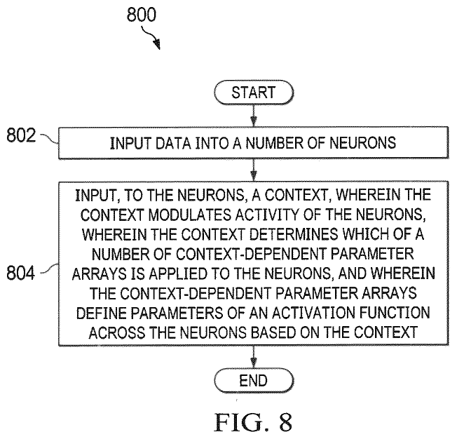

FIG. 8 depicts a flowchart illustrating a process for training a context-modulated classification network in accordance with an illustrative embodiment. Process 800 can be implemented, e.g., in neural network 100 in FIG. 1 or LSM 200 in FIG. 2.

Process 800 begins by inputting data into a number of neurons (step 802). The neurons might comprise a recurrent reservoir. The neurons might comprise spiking neurons.

A context related to the input data is input to the neurons (step 804). The context modulates activity of the neurons, wherein the context determines which of a number of context-dependent parameter arrays is applied to the neurons. The context-dependent parameter arrays define parameters of an activation function across the neurons based on the specific context. In the case of spiking neurons, the parameters comprise spiking threshold biases.

Process 800 then ends.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A context-modulated neural network, comprising:
a number of neurons that receive input data, wherein a context modulates network activity by altering a number of network parameters such that network output depends on a combination of the context and the input data; and
a number of different sets of network parameters governing operation of the network, wherein the context determines which set of parameters is applied to the neurons.

2. The context-modulated neural network of claim 1, wherein the parameters are for an activation function across the neurons.

3. The context-modulated neural network of claim 1, wherein the neurons comprise a recurrent reservoir.

4. The context-modulated neural network of claim 1, wherein the neurons comprise spiking neurons.

5. The context-modulated neural network of claim 1, wherein the parameters are stochastically determined.

6. The context-modulated neural network of claim 1, wherein the parameters are deliberately assigned.

7. The context-modulated neural network of claim 1, wherein the context indicates a speaker of voice data.

8. The context-modulated neural network of claim 1, wherein the context indicates a person performing various motions.

9. A context-modulated neural network, comprising:
a layer of input neurons;
a reservoir comprising a recurrent neural network, wherein connections from the input neurons to neurons in the reservoir, and connections between the neurons in the reservoir, are sparse and fixed, wherein input data fed into the input neurons is projected onto the reservoir, and wherein network activity of the reservoir is modulated according to a context; and
a readout layer that classifies a reservoir state resulting from the input data and the context, wherein output connection weights in the readout layer are trained.

10. The context-modulated neural network of claim 9, wherein the reservoir comprises spiking neurons.

11. The context-modulated neural network of claim 9, further comprising a number of context-dependent parameter arrays that define parameters of an activation function across the reservoir based on the context, wherein the context determines which context-dependent parameter array is applied to the neurons.

12. The context-modulated neural network of claim 11, wherein the parameters comprise spiking threshold biases.

13. The context-modulated neural network of claim 11, wherein the parameters defined by the context-dependent parameter arrays are stochastically determined are stochastically determined.

14. The context-modulated neural network of claim 11, wherein the parameters defined by the context-dependent parameter arrays are deliberately assigned.

15. The context-modulated neural network of claim 9, wherein the context indicates a speaker of voice data.

16. The context-modulated neural network of claim 9, wherein the context indicates a person performing various motions.

17. A method of training a context-modulated neural network, the method comprising:
inputting data into a number of neurons; and
inputting, to the neurons, a context, wherein the context modulates activity of the neurons, wherein the context determines which of a number of context-dependent parameter arrays is applied to the neurons, and wherein the context-dependent parameter arrays define parameters of an activation function across the neurons based on the context.

18. The method of claim 17, wherein the neurons comprise a recurrent reservoir.

19. The method of claim 17, wherein the neurons comprise spiking neurons.

20. The method of claim 19, wherein the parameters comprise spiking threshold biases.
